(19) United States
(12) Patent Application Publication
(10) Pub. No.: US 2006/0270579 A1
(43) Pub. Date: Nov. 30, 2006

(54) Use in a machine dishwashing and rinsing composition of an amphoteric copolymer as soil antiredeposition agent

(76) Inventors: Eric Aubay, Princeton, NJ (US); Garry Embleton, Dublin, CA (US)

Correspondence Address: Jean-Louis Seugnet;RHODIA INC., 259 Prospect Plains Road, Bldg. N-2, CRANBURY, NJ, 08512-7500, US

(21) Appl. No.: 11/499,211

(22) Filed: Aug. 4, 2006

Related U.S. Application Data
(63) Continuation of application No. 10/445,481, filed on May 27, 2003, now abandoned.

(30) Foreign Application Priority Data
May 27, 2002 (FR) 02/06434

(51) Int. Cl. C11D 3/02

(52) U.S. Cl. 510/218; 510/220

(57) ABSTRACT

Use as a soil antiredeposition agent (soil repellent) in a two-in-one or three-in-one washing and rinsing composition for the machine cleaning of kitchen- and tableware of a water-soluble or water-dispersible amphoteric copolymer derived (a) from at least one monomer of the diallyldimethylammonium chloride type (b) and from at least one (potentially) anionic monomer, the a/b molar ratio being between 15/85 and less than 50/50. Method of enhancing the soil antiredeposition properties of a two-in-one or three-in-one washing and rinsing composition for the machine cleaning of kitchen- and tableware by adding to the said composition an effective amount of the said copolymer.

The present invention relates to the use in a two-in-one or three-in-one machine dishwashing and rinsing composition of a water-soluble or water-dispersible amphoteric copolymer as a soil antiredeposition agent (soil repellent). It also relates to a novel industrial product comprising a solid preformulation product, in the form in particular of granules, comprising the said amphoteric copolymer adsorbed and/or absorbed on a water-soluble solid inorganic support and to the use in a two-in-one or three-in-one machine dishwashing and rinsing composition of the said preformulation product as a soil antiredeposition agent (soil repellent).

The application WO 01/5921, filed in the name of the applicant, proposed using, in compositions for treating hard surfaces, water-soluble or water-dispersible amphoteric copolymers derived from at least one cationic monomer from the class of diallyldimethylammonium chloride (DADMAC), from at least one anionic monomer (acrylic acid in particular) and, where appropriate, from at least one nonionic monomer for the purpose of imparting hydrophilic properties to the treated surface. The compositions described are intended for the washing or rinsing of kitchen- and tableware by machine or by hand, for the cleaning of windows, ceramics (bathrooms, sinks, toilet bowls), shower walls and motor vehicle bodies. These compositions give the treated surface in particular lasting run resistance, condensation resistance, spot resistance or mark resistance properties; by lasting spot resistance or mark resistance properties are meant properties which the treated surface retains over the course of time, including after subsequent contact with water, whether it be rainwater, tap water or rinsing water with or without the addition of rinsing products. The purpose here is therefore essentially to prevent spots or marks of water and limescale.

It has been found that the use of these copolymers in machine dishwashing and rinsing compositions does not always make it possible to solve the problems of soil redeposition.

The applicant has now found that an appropriate selection of charge ratio allows amphoteric copolymers based on DADMAC to be employed as soil antiredeposition agents in two-in-one (washing and rinsing) or three-in-one (softening, washing and rinsing) compositions for machine dishwashing.

The invention first provides for the use in a two-in-one or three-in-one washing and rinsing composition for the machine cleaning of kitchen- and tableware of a water-soluble or water-dispersible amphoteric copolymer comprising in the form of polymerized units
(a) at least one monomeric compound of general formula I 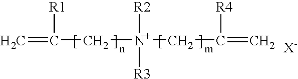
in which

R₁ and R₄ represent independently of one another a hydrogen atom or a linear or branched C₁-C₆ alkyl group;

R₂ and R₃ represent independently of one another an alkyl, hydroxyalkyl or aminoalkyl group in which the alkyl group is a linear or branched C₁-C₆ chain, preferably a methyl group;

n and m are integers of between 1 and 3;

X represents a counterion compatible with the water-soluble or water-dispersible nature of the polymer;

(b) at least one hydrophilic monomer which carries an acidic function, is copolymerizable with (a) and is capable of undergoing ionization in the application medium,

(c) where appropriate, at least one ethylenically unsaturated hydrophilic monomeric compound of neutral charge which carries one or more hydrophilic groups and is copolymerizable with (a) and (b),

wherein the a/b molar ratio is between 15/85 and less than 50/50, preferably between 25/75 and 45/55, as a soil antiredeposition agent (soil repellent).

Preferably,

R₁ represents hydrogen,

R₂ represents methyl,

R₃ represents methyl,

R₄ represents hydrogen, and

m and n are equal to 1.

The ion X⁻ is advantageously selected from halide (chloride, etc.), sulphate, hydrogen sulphate, phosphate, citrate, formate and acetate ions.

The copolymer of the invention advantageously has a molecular mass of at least 1 000, more advantageously of at least 10 000; the molecular mass may range preferably from 50 000 to 500 000.

Unless indicated otherwise, references to molecular mass are to the molecular mass by weight, expressed in g/mol.

The said mass may be determined by aqueous gel permeation chromatography (GPC) or by measuring the intrinsic viscosity in a 1N NaNO₃ solution at 30° C.

The copolymer is preferably random.

Preferentially, the structure of the monomer (a) is as follows: 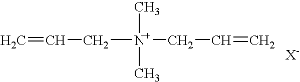
X⁻ being as defined above.

One particularly preferred monomer is that of the above formula in which X⁻ represents Cl⁻, referred to as DADMAC.

The monomers (b) are advantageously water-soluble monoethylenically unsaturated C₃-C₈ carboxylic, sulphonic, sulphuric, phosphonic or phosphoric acids, their anhydrides and their water-soluble salts.

Preferred monomers (b) include carboxylic acids such as acrylic acid, methacrylic acid, α-ethacrylic acid, β,β-dimethylacrylic acid, methylenemalonic acid, vinylacetic acid, allylacetic acid, ethylideneacetic acid, propylideneacetic acid, crotonic acid, maleic acid, fumaric acid, itaconic acid, citraconic acid, mesaconic acid, N-methacryloylalanine, N-acryloylhydroxyglycine, and the alkali metal salts and ammonium salts thereof.

Monomers (c) include acrylamide, vinyl alcohol, the C₁-C₄ alkyl esters of acrylic acid and methacrylic acid, the C₁-C₄ hydroxyalkyl esters of acrylic acid and methacrylic acid, especially ethylene glycol acrylate and methacrylate and propylene glycol acrylate and methacrylate, the polyalkoxylated esters of acrylic acid and methacrylic acid, especially the polyethylene glycol esters and the polypropylene glycol esters.

The proportion of monomers (c) is advantageously between 0 and 50 mol %, preferably 0 to 30 mol %.

The following copolymers are very particularly preferred:

DADMAC/acrylic acid copolymers;

DADMAC/maleic acid copolymers;

DADMAC/itaconic acid copolymers;

the DADMAC/acid monomer molar ratio being between 15/85 and less than 50/50, preferably between 25/75 and 45/55.

Very preferential copolymers are DADMAC/acrylic acid copolymers whose molar ratio is between 15/85 and less than 50/50, preferably between 25/75 and 45/55.

The two-in-one or three-in-one washing and rinsing composition of the invention comprises at least one copolymer as described above at a level of between 0.01% and 10%, preferably between 0.02% and 0.5%, by weight relative to the total weight of the composition.

The composition of the invention generally comprises at least one surfactant. This surfactant is advantageously nonionic and/or anionic and/or amphoteric; it is preferably a nonionic surfactant.

Nonionic surfactants include in particular condensates of alkylene oxide, especially ethylene oxide and, where appropriate, propylene oxide, with alcohols, polyols, alkylphenols, fatty acid esters, fatty acid amides and fatty amines; amine oxides, sugar derivatives such as alkyl polyglycosides or fatty acid esters of sugars, especially sucrose monopalmitate; long-chain tertiary phosphine oxides, dialkyl sulphoxides; block copolymers of polyoxyethylene and of polyoxypropylene; polyalkoxylated sorbitan esters; fatty esters of sorbitan, poly(ethylene oxide)s and fatty acid amides modified so as to give them a hydrophobic character (for example, fatty acid mono- and diethanolamides containing from 10 to 18 carbon atoms).

Mention may be made very particularly of

polyoxyalkylenated C₈-C₁₈ aliphatic carboxylic acids containing from 2 to 50 oxyalkylene (oxyethylene and/or oxypropylene) units, especially C₁₂ (average) or C₁₈ (average) types;

polyoxyalkenylated C₆-C₂₄ aliphatic alcohols containing from 2 to 50 oxyalkylene (oxyethylene and/or oxypropylene) units, in particular C₁₂ (average) or C18 (average) types; mention may be made of Rhodia's Antarox B12DF, Antarox FM33, Antarox FM63 and Antarox V74, BASF's Plurafac LF 400 and Plurafac LF 220, Rhodia's Rhodasurf ID 060, Rhodasurf ID 070 and Rhodasurf LA 42 and ICI's Synperonic A5, A7 and A9.

Amphoteric surfactants include sodium alkyl iminopropionates or iminodipropionates, such as Rhodia's Mirataine H₂C HA and Mirataine JC HA.

The surfactants may be present at from 0.1 to 20%, preferably from 0.2 to 10%, by weight.

The copolymer of general formula (I)/surfactant weight ratio is advantageously between 1/2 and 1/100, more advantageously 1/5 and 1/50.

Unless indicated otherwise, the proportions below are by weight.

Other common additives which form part of the formulation of machine dishwashing detergent compositions include
organic builders or cobuilders (detergency adjuvants enhancing the surface properties of the surfactants) of the following types:
   water-soluble aminophosphonates and organic phosphonates such as

1-hydroxyethane-1,1-diphosphonates

aminotri(methylenediphosphonate)

vinyldiphosphonates

salts of oligomers or polymers of vinylphosphonic or vinyldiphosphonic acid

salts of random copolymers or cooligomers of vinylphosphonic or vinyldiphosphonic acid and acrylic acid and/or maleic anhydride and/or vinylsulphonic acid and/or acrylamidomethylpropanesulphonic acid

salts of phosphonated polycarboxylic acids

polyacrylates containing terminal phosphonate group(s)

salts of cotelomers of vinylphosphonic or vinyldiphosphonic acid and acrylic acid

such as those from the RHODIA BRIQUEST® or MIRAPOL A300 or 400 range (at from 0 to 2% of the total weight of detergent composition, expressed in terms of dry matter);

polycarboxylic acids or their water-soluble salts and water-soluble salts of carboxylic polymers or copolymers such as

polycarboxylate or hydroxypolycarboxylate ethers

polyacetic acids or their salts (nitriloacetic acid, N,N-dicarboxymethyl-2-aminopentanedioic acid, ethylenediaminetetraacetic acid, diethylenetriaminepentaacetic acid, ethylenediaminetetraacetates, nitrilotriacetates, or N-(2-hydroxyethyl)nitrilodiacetates) (at from 0 to 10% of the total weight of detergent composition, expressed in terms of dry matter);

salts of (C₅-C₂₀ alkyl)succinic acids

polycarboxylic acetal esters

salts of polyaspartic or polyglutamic acids

citric acid, gluconic acid or tartaric acid or their salts (at from 0 to 10% of the total weight of detergent composition, expressed in terms of dry matter in the case of a dishwasher composition);
copolymers of acrylic acid and maleic anhydride or homopolymers of acrylic acid, such as Rhodia's Rhodoline DP 226 35 and BASF's Sokalan CP5 (at from 0 to 10% of the total weight of the said detergent composition, expressed in terms of dry matter);
inorganic builders (detergency adjuvants enhancing the surface properties of the surfactants) of the following types:
   alkali metal, ammonium or alkanolamine polyphosphates such as RHODIAPHOS HD7 sold by the company RHODIA (at from 0 to 70% of the total weight of detergent composition, expressed in terms of dry matter);
   alkali metal pyrophosphates;
   alkali metal silicates whose SiO₂/M₂O ratio may range from 1 to 4, preferably from 1.5 to 3.5, very particularly from 1.7 to 2.8; they may be amorphous silicates or phyllosilicates such as the α, β, γ and δ phases of Na₂Si₂O₅, sold under the designations NaSKS-5, NaSKS-7, NaSKS-11 and NaSKS-6 by CLARIANT;
   alkali metal or alkaline earth metal borates, carbonates, bicarbonates and sesquicarbonates (in an amount which may range up to approximately 50% of the total weight of the said detergent composition, expressed in terms of dry matter);
   cogranules of alkali metal silicate hydrates with an SiO₂/M₂O ratio which may range from 1.5 to 3.5 and of alkali metal (sodium or potassium) carbonates; mention may be made in particular of cogranules in which the weight amount of water combined with the silicate relative to the dry silicate is at least 33/100, in which the weight ratio of silicate to carbonate may range from 5/95 to 45/55, preferably from 15/85 to 35/65, as described in EP-A-488 868 and EP-A-561 656, such as NABION 15 sold by the company RHODIA;
      (it being possible for the total amount of organic and/or inorganic builders to represent up to 90% of the total weight of the said detergent composition, expressed in terms of dry matter);
bleaches of the perborate type or percarbonate type which may or may not be combined with acetylated bleach activators such as N,N,N′,N′-tetraacetylethylenediamine (TAED) or chlorinated products of the chloroisocyanurate type, or chlorinated products of the alkali metal hypochlorite type (at from 0 to 30% of the total weight of the said detergent composition, expressed in terms of dry matter, in the case of a dishwasher composition);
fillers of the sodium sulphate or sodium chloride type at from 0 to 50% of the total weight of the said composition, expressed in terms of dry matter;
bleaching catalysts comprising a transition metal, especially complexes of iron, manganese and cobalt, such as those of the type
[Mn^{IV}₂(μ-O)₃(Me₃TACN)₂](PF₆)₂,
[Fe^{II}(MeN₄py)(MeCN)](ClO₄)₂ or
[(Co^{III})(NH₃)₅(OAc)](OAc)₂, which are described in U.S. Pat. Nos. 4,728,455, 5,114,606, 5,280,117, EP-A-909 809, U.S. Pat. No. A-5,559,261, WO 96/23859, 96/23860 and 96/23861;
various other additives, such as agents which influence the pH of the detergent composition, especially alkalifying additives which are soluble in the washing liquor or enzymes or fragrances, dyes and agents which inhibit metal corrosion.

A 3-in-1 washing and rinsing composition differs from a 2-in-1 washing and rinsing composition in particular in a higher concentration of organic builders and of sodium tripolyphosphate.

Preferentially, a 3-in-1 washing and rinsing composition comprises
more than 40% of sodium tripolyphosphate
more than 1% of at least one water-soluble aminophosphonate or organic phosphonate
at least 2% of organic polymer builders or acrylic copolymer builders.

The two-in-one or three-in-one washing and rinsing composition may be in liquid, gel, loose or compacted powder form; preferentially, it is in the form of single-layer or multilayer tablets.

One particularly advantageous embodiment consists in the use, in accordance with the invention, of the said water-soluble or water-dispersible amphoteric copolymers in the form of solid preformulation product, especially in the form of granules, comprising the said amphoteric copolymer adsorbed and/or absorbed on a water-soluble solid inorganic support.

The invention secondly provides, as a novel industrial product, a dry solid preformulation product intended for a two-in-one or three-in-one washing and rinsing composition for an automatic dishwasher, the said preformulation product consisting essentially of a solution or dispersion of the said amphoteric copolymer adsorbed and/or absorbed on a particulate solid support composed of at least one water-soluble inorganic material.

Water-soluble inorganic supports include alkali metal—preferably sodium—sulphates, tripolyphosphates, carbonates, bicarbonates and sesquicarbonates. Very preferentially, the said support is sodium tripolyphosphate, preferably in an anhydride form obtained by atomization.

The amphoteric copolymer/inorganic support weight ratio, expressed in terms of dry matter, is from 5/95 to 50/50, preferably from 10/90 to 30/70.

Preferentially, the said preformulation product takes the form of cogranules having a median diameter of from 250 to 1 000 μm (measurement by particle size sieve analysis).

The said preformulation product is obtainable by granulating the support material in particulate form with the aid of an aqueous solution or dispersion of amphoteric copolymer, the said solution or dispersion having a solids content of from 10 to 40%, preferably from 15 to 35%.

The support material in particulate form may have a median diameter of from 150 to 700 μm.

The granulating operation may be conducted continuously with the aid of a granulating apparatus such as a drum, plate, fluidized bed, etc.

If necessary, the resulting cogranules are dried, particularly in a fluidized bed, in order to enhance their flowability.

The said preformulation product may further comprise other constituents, especially nonionic surfactants and the organic cobuilders already mentioned above.

The invention thirdly provides a method of enhancing the soil antiredeposition properties of a two-in-one or three-in-one washing and rinsing composition for the machine cleaning of kitchen- and tableware by adding to the said composition an effective amount of at least one above-described water-soluble or water-dispersible amphoteric copolymer or of a preformulation product as described above.

The amounts of amphoteric copolymer and the nature and amounts of the other additives present where appropriate have already been mentioned above.

The invention further provides a novel industrial product comprising a high-performance 2-in-1 or 3-in-1 washing and rinsing formulation for machine dishwashing comprising:
at least 20%, preferably from 25 to 60%, by weight of sodium tripolyphosphate,
a sodium silicate with an SiO₂/Na₂O molar ratio ranging from 1 to 4, preferably from 1.5 to 3.5, very particularly from 1.7 to 2.8, in an amount less than 15%, preferably less than 10%, very particularly less than 5%, more particularly in an amount ranging from 1 to less than 5% by weight,
from 0.02 to 0.5% by weight of above-described amphoteric copolymer,
from 0.1 to 20%, preferably from 0.2 to 10%, very particularly from 0.2 to 5%, by weight of nonionic surfactant.
   The abovementioned percentages are expressed in terms of dry matter.

Preferentially, the sodium silicate comprises cogranules of hydrated sodium silicate with an SiO₂/Na₂O ratio which may range from 1.5 to 3.5 and sodium carbonate, in which the weight ratio of silicate to carbonate may range from 5/95 to 45/55, preferably from 15/85 to 35/65, such as NABION 15 sold by Rhodia.

The said 2-in-1 or 3-in-1 formulation may further comprise common additives present in dishwashing compositions, such as those described earlier on above, and in the amounts already mentioned above.

The examples which follow are given by way of illustration.

The abbreviations given have the following meanings:

AA acrylic acid
DADMAC dimethyldiallylammonium chloride
   CH₂═CH—CH₂—N⁺(Me)₂—CH₂—CH═CH₂ Cl⁻
MAPTAC (methacrylamidopropyl)trimethylammonium chloride
   CH₂═C(CH₃)—C(O)—NH—(CH₂)₃—N⁺(Me)³Cl⁻
DiQUAT cationic monomer of formula
   CH₂═C(CH₃)—C(O)—NH—(CH₂)₃—N⁺(Me)₂—CH₂—CH(OH)—CH₂—N⁺(Me)₃ Cl⁻
STPP sodium tripolyphosphate
   Protocol of the Soil Antiredeposition Test

The washing and rinsing formulation is employed in the dishwasher by introducing it into the compartment in the machine that is provided for this purpose.

20 g of conventional detergent powder containing 0.1% or 0.2% of test polymer are employed in this way.

The test is carried out on 10 soda glasses disposed in a regular fashion in the machine.

40 grams of “soiling” are introduced into the dishwasher. The soiling used is a mixture of salad cream (50%), ketchup (5%), mayonnaise (10%), milk (25%) and creme fraîche (10%).

Three successive cycles at 65° C. are carried out under identical conditions.

When dry, the glasses are evaluated (on criteria of transparency, brilliance and absence of marks) by a panel of 15 trained individuals, who award scores of between −10 and +10 on the following scale:
−10: soil deposit, white haze or soil marks much more visible than on the control
−5: soil deposit, white haze or soil marks more visible than on the control
0: conventional powder without polymer (control): white haze and soil marks clearly visible
+3: 12 to 24 soil marks, white haze
+5: 4 to 12 soil marks, slight white haze
+7: less than 4 soil marks, very slight white haze
+10: clean glass, no soil marks or white haze

Test Polymers:

| | |
|---|---|
| AA/DADMAC | with a molar distribution of 85/15 |
| AA/DADMAC | with a molar distribution of 70/30 |
| AA/DADMAC | with a molar distribution of 60/40 |
| AA/DADMAC | with a molar distribution of 50/50 |
| AA/DIQUAT | with a molar distribution of 60/40 |
| AA/MAPTAC | with a molar distribution of 60/40 |

### EXAMPLE 1

### 3-in-1 Tablet or Powder Formula

The test is carried out in hard water (400 TH) with no rinsing salts or regenerating salt.

The formulation tested is as follows:

| | |
|---|---|
| NABION 15 (builder, sodium silicate/carbonate | 25% |
| cogranules) | |
| Rhodiaphos HD7 (STPP) | 52% |
| Antarox B12 DF (nonionic surfactant, defoamer) | 0.9% |
| Antarox B79R (nonionic surfactant) | 0.9% |
| Briquest 543-25S (phosphonates) | 1.1% |
| Perborate monohydrate (bleach) | 8% |
| TAED (bleach catalyst) | 2% |
| Rhodoline DP 226 35 (polymeric builder) | 2% |
| Amylase (enzyme) | 1.3% |
| Protease (enzyme) | 0.7% |
| Test polymer | 0.2% |
| Na₂SO₄ | 5.9% |

The formulation is in the form of a powder or else in the form of a tablet with a diameter of 44 mm and a thickness of 1 cm, obtained by compacting 20 g of powder under a pressure of 2 MPa.

The results are as follows:

| | | | | | Control |
|---|---|---|---|---|---|
| AA/DADMAC | AA/DADMAC | AA/DADMAC | AA/DIQUAT | AA/MAPTAC | without |
| 85/15 | 60/40 | 50/50 | 60/40 | 60/40 | polymer |
| +6 | +9 | +4 | +2 | +2 | 0 |

A real advantage in terms of soil antiredeposition and rinsing is found to be provided by the presence of 0.2% of AA/DADMAC copolymers with a molar distribution of 85/15 and 60/40, relative to the control, and also relative to the AA/DIQUAT copolymers with a molar distribution of 60/40 and 50/50 or AA/MAPTAC copolymer with a molar distribution of 60/40.

### EXAMPLE 2

### 2-in-1 Tablet or Powder Formula

The test is carried out in soft water (<5° TH) with no rinsing salt.

The formulation tested is as follows:

| | |
|---|---|
| NABION 15 (builder, sodium silicate/carbonate | 34% |
| cogranules | |
| Rhodiaphos HD7 (STPP) | 30% |
| Antarox B12 DF (nonionic surfactant, defoamer) | 0.8% |
| Antarox B79R (nonionic surfactant) | 0.8% |
| Briquest 543-45AS (phosphonates) | 0.8% |
| Perborate monohydrate (bleach) | 8% |
| TAED (bleach catalyst) | 2% |
| Rhodoline DP 226 35 (polymeric builder) | 1.5% |
| Amylase (enzyme) | 1.3% |
| Protease (enzyme) | 0.7% |
| Na₂SO₄ | 20% |
| Test polymer | 0.1% |

The formulation is in the form of a powder or else in the form of a tablet with a diameter of 44 mm and a thickness of 1 cm, obtained by compacting 20 g of powder under a pressure of 4 MPa.

The results are as follows:

| | | | | AA/ | Control |
|---|---|---|---|---|---|
| AA/DADMAC | AA/DADMAC | AA/DADMAC | AA/DIQUAT | MAPTAC | without |
| 85/15 | 60/40 | 50/50 | 60/40 | 60/40 | polymer |
| +5 | +7 | +3 | +1 | +1 | 0 |

A real advantage in terms of soil antiredeposition and rinsing is found to be provided by the presence of 0.1% of AA/DADMAC copolymers with a molar distribution of 85/15 and 60/40, relative to the control, and also relative to the AA/DIQUAT copolymers with a molar distribution of 60/40 and 50/50 or AA/MAPTAC copolymer with a molar distribution of 60/40.

### EXAMPLE 3

### 3-in-1 Formulation

The operation described in example 1 is carried out by employing the formulations given in the table below.

| Formulation | | |
|---|---|---|
| Nonionic surfactant | 0.9% | 0.9% |
| Anhydrous STPP | 50% | 50% |
| Sodium perborate monohydrate | 8% | 8% |
| Sodium disilicate | 14%* | 3.48%** |
| Sodium carbonate | 6.6% | 6.6%** |
| Sokalan CP5 (polymeric builder) | 2% | 2% |
| Phosphonate | 1% | 1% |
| TAED | 2% | 2% |
| Enzymes (protease + amylase) | 2% | 2% |
| 60/40 AA/DADMAC polymer | 0.1% | 0.1% |
| Sodium sulphate | qs 100 | qs 100 |
| Test result | +5 | +9 |

*provided by atomized sodium disilicate (80%)
**provided by 12% of Nabion 15

It is evident that the advantage in terms of soil antiredeposition and rinsing improves as the disilicate content goes down.

### EXAMPLE 4

### 3-in-1 Formulation

The operation described in example 1 is carried out by employing the formulations given in the table below.

Formulation

| | | | | |
|---|---|---|---|---|
| Nonionic surfactant | 1.8% | 1.8% | 1.8% | 1.8% |
| Anhydrous STPP | 52% | 52% | 52% | 52% |
| Sodium perborate | 8% | 8% | 8% | 8% |
| monohydrate | | | | |
| Sodium disilicate | 3.48%** | 7%* | 12%* | 18%* |
| Sodium carbonate | 6.6%** | 6.6% | 6.6% | 6.6% |
| Briquest 543-25S | 1.1% | 1.1% | 1.1% | 1.1% |
| (phosphonates) | | | | |
| Rhodoline DP 226 35 | 2% | 2% | 2% | 2% |
| (polymer builder) | | | | |
| TAED | 2% | 2% | 2% | 2% |
| Enzymes (protease + amylase) | 2% | 2% | 2% | 2% |
| 70/30 AA/DADMAC polymer | 0.1% | 0.1% | 0.1% | 0.1% |
| Sodium sulphate | qs 100 | qs 100 | qs 100 | qs 100 |
| Test result | +9 | +8 | +5 | +3 |

*provided by atomized sodium disilicate (80%)
**provided by 12% of Nabion 15

It is evident that the advantage in terms of soil antiredeposition and rinsing improves as the disilicate content goes down.

1-22. (canceled)

23. 2-in-1 or 3-in-1 washing and rinsing formulation for machine dishwashing, comprising:
at least 20%, by weight of sodium tripolyphosphate;
a sodium silicate with a SiO₂/Na₂O molar ratio ranging from 1 to 4, in an amount less than 15% by weight;
from 0.02 to 0.5% by weight of an amphoteric copolymer comprising in the form of polymerized units:
(a) at least one monomeric compound of general formula I: 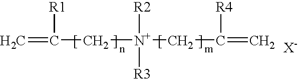
wherein:
R₁ and R₄ represent independently of one another a hydrogen atom or a linear or branched C₁-C₆ alkyl group;
R₂ and R₃ represent independently of one another an alkyl, hydroxyalkyl or aminoalkyl group wherein the alkyl group is a linear or branched C₁-C₆ chain;
n and m are integers of between 1 and 3; and
X represents a counterion compatible with the water-soluble or water-dispersible nature of the polymer;
(b) at least one hydrophilic monomer which carries an acidic function, is copolymerizable with (a) and is capable of undergoing ionization in an application medium,
(c) optionally, at least one ethylenically unsaturated hydrophilic monomeric compound of neutral charge which carries one or more hydrophilic groups and is copolymerizable with (a) and (b), and
wherein the a/b molar ratio is between 15/85 and less than 50/50; and
from 0.2 to 5%, by weight of nonionic surfactant.

24. 2-in-1 or 3-in-1 washing and rinsing formulation according to claim 42, comprising:
from 25 to 60%, by weight of sodium tripolyphosphate,
a sodium silicate with an SiO₂/Na₂O molar ratio ranging from 1.7 to 2.8, and
in an amount ranging from 1 to less than 5% by weight, and
from 0.2 to 5%, by weight of nonionic surfactant.

25. 2-in-1 or 3-in-1 washing and rinsing formulation according to claim 24, wherein the sodium silicate is in the form of cogranules of hydrated sodium silicate with an SiO₂/Na₂O ratio ranging from 1.5 to 3.5 and sodium carbonate, the weight ratio of silicate to carbonate ranging from 5/95 to 45/55.

26. 2-in-1 or 3-in-one washing and rinsing formulation according to claim 23, wherein the amphoteric copolymer is provided as a dry preformulation consisting essantially of a solution or dispersion adsorbed or absorbed on a particulate solid support composed of at least one water soluble inorganic material.

27. 2-in-1 or 3-in-one washing and rinsing formulation according to claim 26, wherein the inorganic support is the sodium tripolyphosphate.

28. 2-in-1 or 3-in-one washing and rinsing formulation according to claim 26, wherein the amphoteric copolymer and the inorganic support have a weight ratio, expressed in terms of dry matter, of from 10/90 to 30/70.

29. The 2-in-1 or 3-in-1 washing and rinsing formulation according to claim 23, wherein
R₁ represents hydrogen,
R₂ represents methyl,
R₃ represents methyl,
R₄ represents hydrogen, and
m and n are equal to 1.

30. The 2-in-1 or 3-in-1 washing and rinsing formulation according to claim 23, wherein the ion X⁻ is halide, sulphate, hydrogen sulphate, phosphate, citrate, formate or acetate ion.

31. The 2-in-1 or 3-in-1 washing and rinsing formulation according to claim 23, wherein the monomer (a) is DADMAC of the following structure: 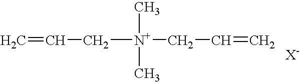
wherein X⁻ represents Cl⁻.

32. The 2-in-1 or 3-in-1 washing and rinsing formulation according to claim 23, wherein the monomer (b) are water-soluble monoethylenically unsaturated C₃-C₈ carboxylic, sulphonic, sulphuric, phosphonic or phosphoric acids, their anhydrides and their water-soluble salts.

33. The 2-in-1 or 3-in-1 washing and rinsing formulation according to claim 23, wherein the optional monomer (c) is acrylamide, vinyl alcohol, the C₁-C₄ alkyl esters of acrylic acid and methacrylic acid, the C₁-C₄ hydroxyalkyl esters of acrylic acid and methacrylic acid, or the polyalkoxylated esters of acrylic acid and methacrylic acid.

34. The 2-in-1 or 3-in-1 washing and rinsing formulation according to claim 23, wherein the water-soluble or water-dispersible amphoteric copolymer is:
DADMAC/acrylic acid copolymer;
DADMAC/maleic acid copolymer; or
DADMAC/itaconic acid copolymer;
wherein the DADMAC/acid monomer molar ratio being between 15/85 and less than 50/50.
